(19) United States
(12) Patent Application Publication
(10) Pub. No.: US 2018/0077956 A1
(43) Pub. Date: Mar. 22, 2018

(54) TIME ACCELERATED ENHANCED-TENDERNESS COOKING PROCESS

(71) Applicant: Harold Harkema, Round Rock, TX (US)

(72) Inventor: Harold Harkema, Round Rock, TX (US)

(21) Appl. No.: 15/271,775

(22) Filed: Sep. 21, 2016

(51) Int. Cl. A23L 13/40; A23L 13/70; A23B 4/052; B65B 25/06

(52) U.S. Cl. CPC A23L 13/428; A23L 13/72; A23V 2002/00; B65B 25/067; A23B 4/052

(57) ABSTRACT

Apparatus and associated methods relate to producing jerky by marinating and cooking a sliced piece of meat in a period of time less than 1 hour. In an illustrative example, the sliced piece of meat may marinate for a time between 3 minutes to 5 minutes. The sliced piece of meat may then cook for 30 minutes, for example, at a temperature of about 350-degrees Fahrenheit. The sliced piece of meat may include a dimension between about 1/7 and about 1/9 of an inch. Advantageously, a user may fully prepare a sliced piece of tender jerky in less than 1 hour.

### TECHNICAL FIELD

Various embodiments relate generally to apparatus and methods for making jerky.

### BACKGROUND

Snack foods are popular in part because they are easily portable. The nutritious qualities of edible jerky have made edible jerky a popular consumer snack. Additionally, edible jerky typically does not require refrigeration, making it ideal for storing when on trips.

Beef is commonly used when making jerky. Other meats, such as turkey may also be used. The meat is usually marinated for hours. After marinating the meat, dehydrators, for example, are commonly used to remove the water content of the meat and cook it.

### SUMMARY

Apparatus and associated methods relate to producing jerky by marinating and cooking a sliced piece of meat in a period of time less than 1 hour. In an illustrative example, the sliced piece of meat may marinate for a time between 3 minutes to 5 minutes. The sliced piece of meat may then cook for 30 minutes, for example, at a temperature of about 350-degrees Fahrenheit. The sliced piece of meat may include a dimension between about 1/7 and about 1/9 of an inch. Advantageously, a user may fully prepare a sliced piece of tender jerky in less than 1 hour.

Various embodiments may achieve one or more advantages. For example, some embodiments may permit a user to increase the production of jerky over a period of time because of the reduced marinating time of about 5 minutes. Advantageously, a user may use a gas-powered smoker to adjust moisture to increase a level of tenderness of the jerky. The gas-powered smoker may include a liquid container such that the user may monitor a liquid, such as water, for example, in the container to prescribe a predetermined level of moisture while cooking the jerky.

In some embodiments, a user may reduce ingredients necessary for mixing a marinade, such as, for example, ¾ teaspoon ground peppercorn spice, ½ teaspoon garlic salt spice and 1¾ ounce of soy sauce per 1 pound of meat. As such, a user may reduce production costs associated with the number of ingredients needed to prepare the meat. Further, a user may increase production of the amount of jerky because the cooking time for a batch of jerky may be about 30 minutes.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts a perspective view of a manufacturing facility implementing an exemplary method for making jerky.

FIG. 2 depicts a schematic view of an exemplary recipe controller.

FIG. 3 depicts a flowchart illustrating an exemplary jerky preparation sequence.

FIG. 4. depicts a graph illustrating recipe parameters as a function of thickness of a meat strip.

FIG. 5 depicts a perspective view of a gas-powered smoker for implementing an exemplary jerky preparation sequence.

FIG. 6A depicts a slidable exhaust for an exemplary smoker.

FIG. 6B depicts a rotatable exhaust for an exemplary smoker.

Like reference symbols in the various drawings indicate like elements.

### DETAILED DESCRIPTION OF ILLUSTRATIVE EMBODIMENTS

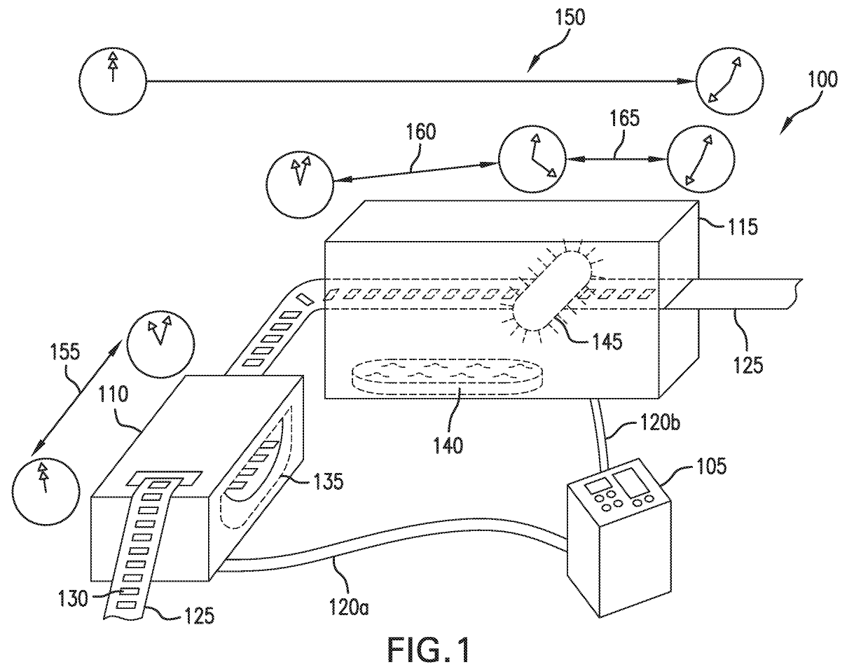

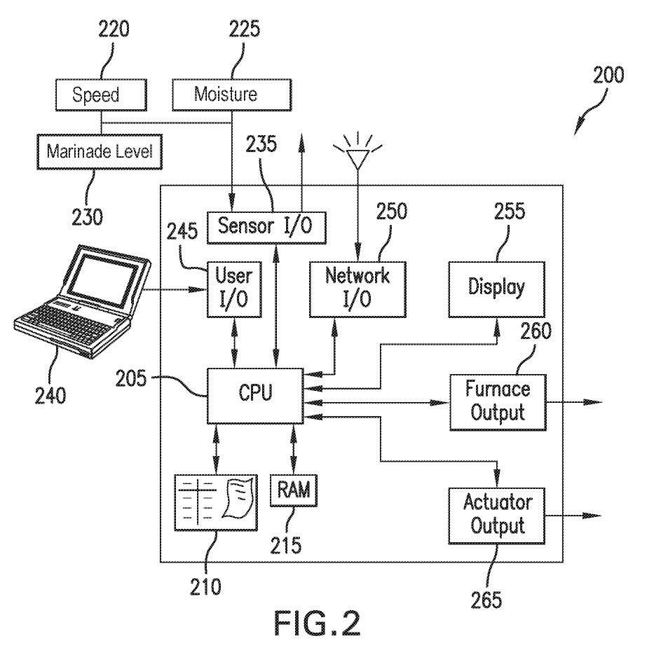

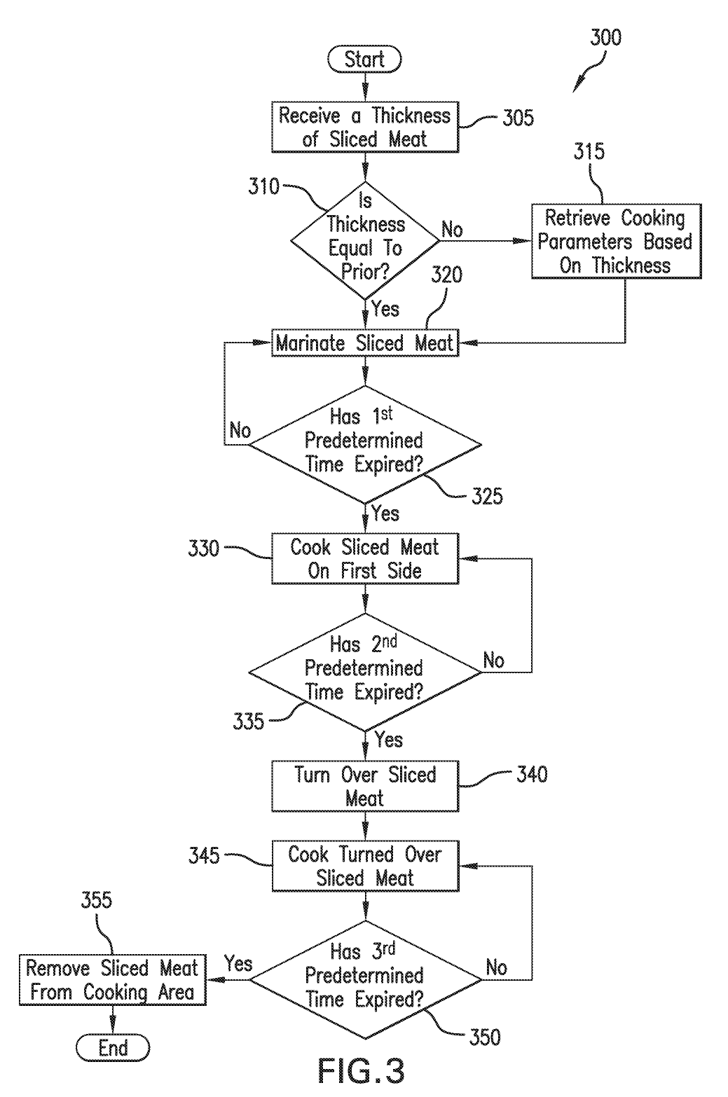

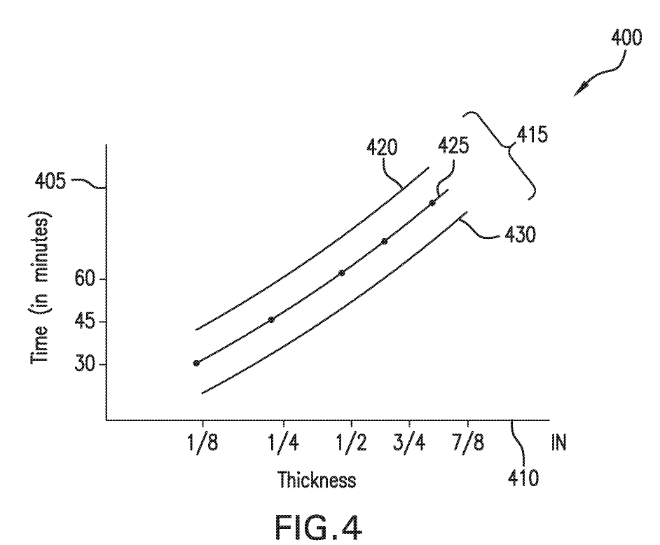

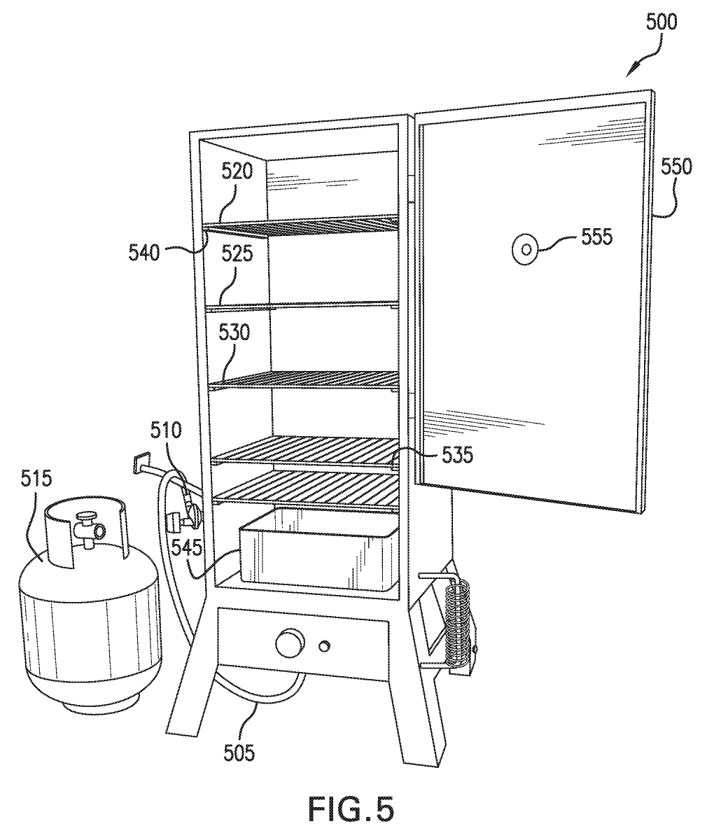

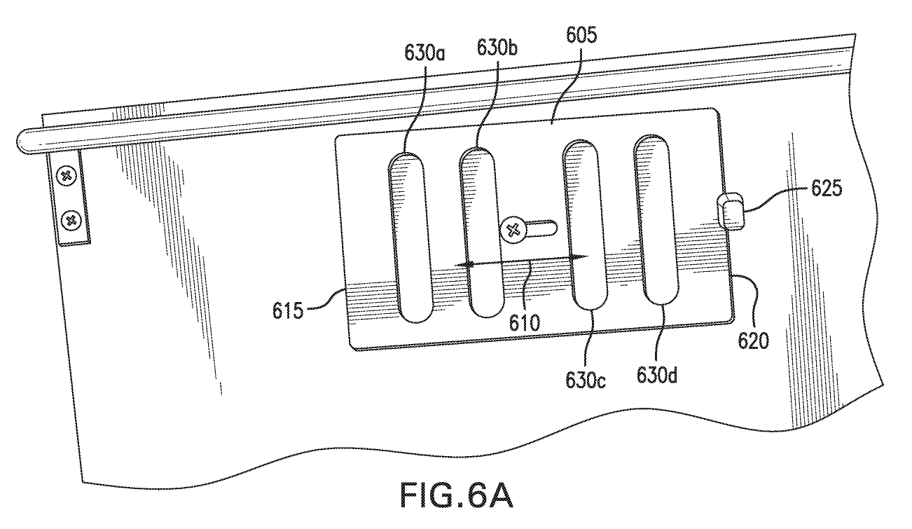

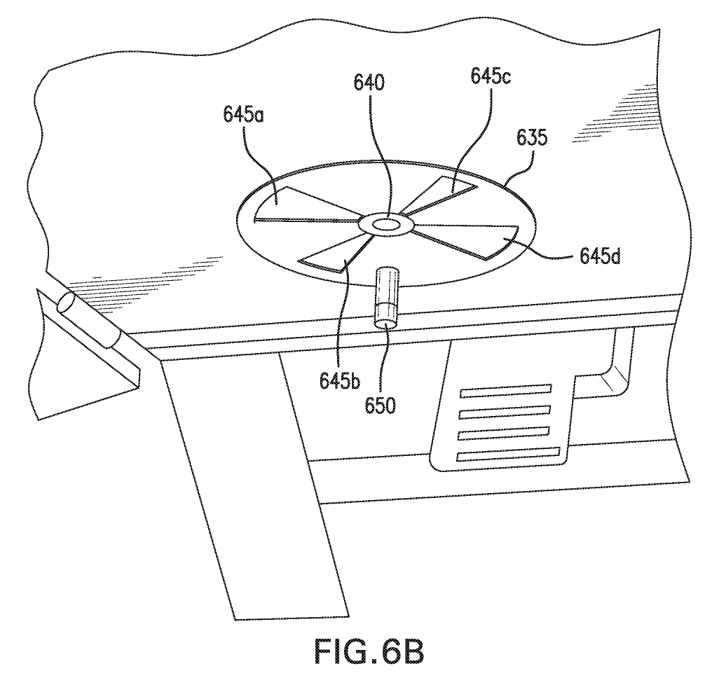

To aid understanding, this document is organized as follows. First, a manufacturing facility implementing an exemplary method for making jerky is briefly introduced with reference to FIG. 1. Second, with reference to FIG. 2, the discussion turns to exemplary embodiments that illustrate a recipe controller configured to implement an exemplary method for making jerky. With reference to FIGS. 3-4, a flowchart and a graph illustrate an exemplary jerky preparation sequence. Finally, with reference to FIGS. 5-6B, the discussion turns to a gas-powered smoker which may be used while implementing an exemplary method for making jerky.

FIG. 1 depicts a perspective view of a manufacturing facility implementing an exemplary method for making jerky. A manufacturing facility 100 implements a sequence of steps for making enhanced-tenderness jerky at an accelerated rate. The manufacturing facility 100 includes a control station 105 that operably connects to a marinating station 110 and a cooking station 115 via cables 120a, 120b, respectively. A conveyor belt 125 carrying meat strips 130 travels along a path through the marinating station 110 and the cooking station 115. The control station 105, in accordance with the sequence of steps, may prescribe a speed for the conveyor belt 125 such that the meat strips 130 marinate and cook under a predetermined period of time, such as, for example, 32 minutes. Advantageously, a user may accelerate the production of jerky because of the reduced time necessary to produce the jerky.

The marinating station 110 includes a dipping bowl 135. The dipping bowl 135 may be filled with marinade. The meat strips 130 may marinate for a predetermined marinate time while traveling on the conveyor belt 125 through the marinating station 110 via the dipping bowl 135. The cooking station 115 includes a liquid pan 140 and a flip module 145. The liquid pan 140 may contain a liquid, such as water, for example, to generate vapor within the cooking station 115. The generated vapor may increase the tenderness of the meat strips 130 when cooked. As such, the level of tenderness may correspond the moisture content (e.g., humidity) during cooking. In some embodiments, a mist system may be used to maintain a humidity level within the cooking station 115. The flip module 145 may flip the meat strips 130 such that the meat strips 130 turn over on the conveyor belt 125 to permit more evenly cooking the meat strips 130.

The meat strips 130 may travel along the conveyor belt 125 through the marinating station 110 and the cooking station 115 in an accumulated period of time 150. The accumulated period of time 150 includes various periods of times 155-165, each period of time 155-165 corresponds to a specific action. For example, a first predetermined period of time 155, as depicted, corresponds to the period that the meat strips marinate in the marinating station 110 via the dipping bowl 135. A second predetermined period of time 160 defines the period for which the meat strips 130 cook before reaching the flip module 145. A third period of time 165 defines the remaining period that the meat strips 130 cook after being turned over by the flip module 145. As depicted, each period of time 155, 160, 165 is 5 minutes, 20 minutes, and 10 minutes, respectively. In some embodiments, a user may produce jerky without the need to dehydrate the meat strips 130 via a dehydrator, for example.

In various embodiments, a predetermined marinate time may substantially equal the first predetermined period of time 155. A predetermined cooking time may substantially equal the sums of the second predetermined period of time 155 and the third predetermined period of time 160. The sum of the predetermined periods of time 155-165 defines the accumulated period of time 150. As such, the accumulated period of time 150 elapsed is thirty-five minutes. In some embodiments, a period of time from when the meat strips 130 exit the marinating station 110 and enter the cooking station 115 may be a predetermined period, such as 30 seconds, for example, to decrease marinade erosion from the meat strips 130.

The control station 105 may receive sensor information for the marinating station 110, the cooking station 115, and the conveyor belt 125. For example, the control station 105 may receive temperature information from the cooking station 115. In response to the received temperature information, the control station 105 may adjust the temperature of the cooking station 115, for example, to achieve a predetermined temperature for cooking the meat strips 130. The control station 105 may receive moisture information from the cooking station 115, and, in response, may generate and transmit an indicator to a user to refill the liquid in the liquid pan 140, for example. Alternatively, the control station 105 may trigger an automated filling apparatus (not shown) to refill the liquid pan.

A minor dimension of the meat strips 130 may define a thickness for the meat strips. The control station 105 may receive a thickness for the meat strips 130 via direct input from a user. In various embodiments, a sensor (e.g., optical image scanner) may automate the detection of a thickness to minimize user interaction. The control station 105 may include a controller (described below in further detail) that includes a predetermined set of parameters associated with the received thickness. The control station 105 may determine, via the controller, a set of parameters as a function of the received thickness. In various embodiments, the control station 105 may operate the marinating station 110, the cooking station 115, and the conveyor belt 125 in accordance with the set of parameters.

The control station 105 may operably connect to a slicer module (not shown). The slicer module may receive a lump piece of meat which the slicer module cuts into the meat strips 130. The slicer module may include programming to slice a piece of meat at a predetermined thickness in accordance with the type of meat. For example, a slicer may slice flank steak at about ⅛-inch thickness while slicing skirt steak at about ¼-inch thickness. The slicer module may place the meat strips 130 on the conveyor belt 125. In some embodiments, a user may slice the lump piece of meat manually. The user may freeze and partially thaw the lump piece of meat to facilitate slicing the meat. In various embodiments, the user may use various types of meats, such as turkey, for example.

FIG. 2 depicts a schematic view of an exemplary recipe controller. A recipe controller 200 includes a central processing unit (CPU) 205. The CPU 205 operably connects to non-volatile memory (NVM) 210, such as a data store, for example, and random accessing memory (RAM) 215. The NVM 210 may include various sets of parameters that correspond to various thicknesses of sliced meat (e.g., meat strips 130). The NVM 210 may further include different sets of parameters for similar thicknesses in accordance with the type of meat. For example, a first set of parameters may correspond to a sliced piece of flank steak with ⅛-inch thickness, while a second set of parameters may correspond to a ⅛-inch thick sliced piece of sirloin steak.

With reference to FIG. 1, the CPU 205 operably connects to sensors 220, 225, 230 via a sensor interface 235 to receive information regarding a speed of the conveyor belt 125, a moisture within the cooking station 115, and a marinade level in the dipping bowl, respectively. A computer 240 operably connects to the CPU 205 via a user interface 245. The CPU 205 may receive direct user input from the computer 240. For example, a user may enter a thickness for the meat strips 130. In response, the CPU 205 retrieves a set of parameters corresponding to the entered thickness from the NVM 210. The CPU 205 may use the retrieved set of parameters to operate the marinating station 110, the cooking station 115, and the conveyor belt 125. The CPU 205 may retrieve the predetermined periods of times 155-165 based on the thickness entered by the user. In various embodiments, the user may enter the type of meat (e.g., round steak). The user may adjust, via the computer 240, the periods of times 155-165 to achieve various textures (e.g., toughness vs. tenderness). In various embodiments, a portable electronic device (e.g., smartphone) may also be used to transmit and receive information from the user via the user interface 245.

The CPU 205 operably connects to a network interface 250. A wireless module operably connects to the network interface 250 to transmit and receive signals from a wireless capable device. A user may use a portable device, such as a smartphone, for example, to respond to an alert from the CPU 205. For example, the CPU 205 may detect from a temperature sensor 225 whether the temperature is outside of a predetermined temperature range indicating a possible malfunction within the cooking station 115. The user may receive the alert on the portable device and respond accordingly via the portable device, such as, for example, transmitting a shutdown command to prevent potential waste.

A display interface 255 operably connects to the CPU 205. The CPU 205 may transmit, via the display interface 255, information regarding operation of the marinating station 110, the cooking station 115, and the conveyor belt 125 such that a user may adjust parameters relative to the marinating station 110, the cooking station 115, and the conveyor belt 125 if necessary. A furnace output 260 operably connects to the CPU 205. The CPU 205 may transmit temperature adjustments to the cooking station 115 via the furnace output 260. In various examples, the CPU 205 may determine the temperature adjustments to transmit in response to received sensor input 220-230. An actuator output 265 operably connects to the CPU 205 such that the CPU 205 may transmit actuator commands via the actuator output 265. For example, in response to received velocity information from the velocity sensor 220, the CPU 205 may adjust the speed of the conveyor belt 125.

In various embodiments, the CPU 205 may respond to sensor information in accordance with a predetermined set of parameters. For example, the CPU 205 may receive information regarding the moisture within the cooking station 115 from sensor 225. In response, the CPU 205 may trigger the refilling of the liquid pan 140 if the sensor 225 indicates that the moisture within the cooking stations is below a predetermined threshold, for example.

FIG. 3 depicts a flowchart illustrating an exemplary jerky preparation sequence. With reference to FIG. 2, a CPU 205 implements a jerky making process (BJMP) 300. The CPU 205 receives, at 305, a thickness of a meat strip 130, with reference to FIG. 1. The CPU 205 may receive the thickness information from the computer 240 via the user interface 245. The CPU 205 may receive the thickness information from a sensor, such as an optical image sensor, for example, via the sensor interface 235. At 310, the CPU 205 compares the received thickness to a previous thickness to determine if the received thickness and the previous thickness are substantially equal. The NVM 210 may store the previous thickness. In the event the NVM 210 does not include a previous thickness, the CPU 205 may retrieve, from the NVM 210, a predetermined initial previous thickness. The predetermined initial previous thickness may be based on a predetermined threshold thickness.

If the received thickness does not substantially equal the previous thickness, the CPU 205 retrieves, at 315, a set of parameters based on the received thickness. The CPU 205 may retrieve the set of parameters from the NVM 210. In response to the retrieved parameters, the CPU 205 operates the conveyor belt 125 and the marinating station 110, with reference to FIG. 1, at 320, to marinate the meat strips 130. If the received thickness does substantially equal the previous thickness, the CPU 205 proceeds to marinate, at 320, the meat strips 130 via the conveyor belt 125 and the marinating station 110. At 325, the CPU 205 determines whether a first predetermined time has expired. The CPU 205 may retrieve the first predetermined time from the NVM 210. The retrieved parameters, at 315, may include the first predetermined time. If, at 325, the first predetermined time has not expired, the meat strips 130 continue to marinate, at 320. If, at 325, the first predetermined time has expired, the CPU 205 may operate the conveyor belt 125 and the cooking station 115 to cook, at 330, the meat strips 130. The first predetermined time may be 5 minutes such as, for example, the first predetermined timed 155.

At 335, the CPU 205 determines whether a second predetermined time has expired. The second predetermined time may also be included in the retrieved parameters, at 315. If, at 335, the second predetermined time has not expired, the CPU 205 continues to operate the conveyor belt 125 and the cooking station 115 to cook, at 330, the meat strips 130. If the second predetermined time has expired, the CPU 205 operates, at 340, the conveyor belt 125 and the flip module 145 to turn over the meat strips 130 and cook, at 345, the turned over meat strips 130.

The CPU 205 determines, at 350, whether a third predetermined time has expired. In the event that the third predetermined time has not expired, the meat strips 130 continue to cook, at 345. If the third predetermined time has expired, the CPU 205 operates, at 355, the conveyor belt 125 to remove the meat from the cooking station 115.

In various embodiments, the CPU 205 may operate the conveyor belt 125 to transfer the cooked meat strips 130 to a packing module. The packing module may include a cooling area before packing the cooked meat strips 130. A fourth predetermined time may dictate the period of time that the meat strips 130 remain in the cooling area. The CPU 205 may receive the predetermined periods of times 155-165 via the user interface 245.

FIG. 4. depicts a graph illustrating recipe parameters as a function of thickness of a meat strip. The graph 400 illustrates recipe parameters as a function of thickness 410. As depicted, the recipe parameters include accumulated cooking times 405 and temperature plots 415. The graph 400 illustrates the accumulated cooking times 405 as a function of thickness 410 at different temperatures 415. The temperature plots 420, 425, 430 illustrate accumulated cooking times for cooking temperatures, such as 300 degrees Fahrenheit, 350 degrees Fahrenheit and 400 degrees Fahrenheit, respectively.

At a thickness of an eighth of an inch, the cooking times vary depending on the temperature plots 420-430. For example, with reference to FIG. 1, at 400 degrees Fahrenheit, the accumulated time for cooking a meat strip 130 may equal approximately 20 minutes. At 350 degrees Fahrenheit, the meat strip 130 cooks at an approximately accumulated time of 30 minutes. In various embodiments, with reference to FIG. 2, the NVM 210 may include the temperature plots 420-430 as parameters such that the CPU 205 may determine cooking parameters based on the thickness of the meat strip 130. In an illustrative example, a meat strip 130 having a ⅛-inch thickness cooks at 350 degrees Fahrenheit for a total accumulated time of 30 minutes. A meat strip 130 having a thickness between 1/7-inch and ¼-inch cooks between 30 to 45 minutes in accordance with temperature plot 425. In various embodiments, the thickness 410 may be adjusted to modify the accumulated cooking time 405. The temperature 415 may also be adjusted to modify the accumulated cooking time 405.

FIG. 5 depicts a perspective view of a gas-powered smoker for implementing an exemplary jerky preparation sequence. A smoker 500 includes a gas hose 505. The gas hose 505 includes a coupler 510 at a distal end configured to releasably couple to a fuel source 515, such as a propane container, for example. The smoker 500 includes cooking surfaces 520-535 arranged in rows within a chamber of the smoker 500. As depicted, each cooking surface 520-535 slidably engages the smoker 500 via slide rails 540. A fluid container 545 slidably couples within the chamber of the smoker 500 below the cooking surface 535. A door 550 hingedly attaches to a frame of the smoker 500. As depicted, the door 550 encloses the cooking surfaces 520-535 when closed. The fluid container 545 remains exposed when the door 550 is closed such that a user may access the fluid container 545, such as, for example, when the door 550 is closed for cooking. In various embodiments, a second door may hingedly attach to the frame such that the second door may be opened to provide access to only the fluid container 545. The user may refill the fluid container 545 without opening the door 550. The door 550 includes a temperature sensor 555 to assist the user to maintain a cooking temperature.

A user may use the smoker 500 to implement the jerky preparation sequence. The user may preheat the smoker 500 to a predetermined cooking temperature, such as 350 degrees Fahrenheit, for example, in accordance with the recipe parameters of FIG. 4. The user may fill the fluid container 545 with a fluid, such as water, for example, to generate smoke or vapor. The user may slice a piece of meat into meat strips (e.g., meat strips 130). The user may mix a marinating solution in a bowl, for example. In an illustrative example, the user may mix ½ teaspoon of garlic sauce, ½ teaspoon of ground peppercorn and 1 ounce of soy sauce in a bowl per 1 pound of meat strips. The user may marinate meat strips in the bowl for a first predetermined period of time such as five minutes, for example. In response to the first predetermined period of time expiring, the user may lay the meat strips flat across the cooking surfaces 520-535. The user may slidably engage the cooking surfaces 520-535 within the chamber of the smoker 500 to cook the meat strips for a second predetermined period of time such as 20 minutes, for example.

In response to the second predetermined period of time expiring, the user may remove the cooking surface 520-535 from the chamber. The user may turn over the meat strips on the cooking surfaces 520-535. When the user has turned over the meat strips, the user may insert the cooking surfaces 520-535 into the smoker 500 for a third predetermined period of time, for example, 10 minutes. In response to the third predetermined period of time expiring, the user may remove the meat strips from the smoker 500 so that the meat strips may cool down before consumption or packaging. In some embodiments, a user need not dehydrate the meat strips before packaging. Packaging may include packaging materials adapted to prevent the spoilage of the cooked meat strips. The packaging materials may include a drying agent (e.g., desiccants) or a material to absorb gases and/or liquids (e.g., sorbents). A freshness packet based on silicon, for example, may be used to maintain the freshness of the jerky. A user may use vacuum packing to package the meat strips. In some embodiments, a user may use vacuum packing and a freshness packet to increase the preservative properties of the meat strips.

In some embodiments, a secondary cooking surface may sandwich the meat strips between the cooking surface 520 and the secondary cooking surface, for example. The user may flip the cooking surface 520 and the secondary cooking surface as one piece such that the meat strips turn over within the smoker 500. The user may decrease the overall time because each meat strip need not be turned over individually.

FIG. 6A depicts a slidable exhaust release for an exemplary smoker. An exhaust release 605 slidably attaches the smoker 500, with reference to FIG. 5. The exhaust release 605 includes an axis 610 defined along a proximal end 615 and a distal end 620. As depicted, a lever 625 extends from the distal end 620 such that the lever 625 permits a user to slide the exhaust release 605 along the axis 610. The exhaust release 605 includes apertures 630a-630d. The apertures 630a-630d may be arranged to align with apertures (not shown) of the smoker 500. In response to the apertures 630a-630d at least partially aligning with the apertures of the smoker 500, smoke contained within the chamber of the smoker 500 may be released. A user may control the temperature within the chamber via the exhaust release.

FIG. 6B depicts a rotatable exhaust release for an exemplary smoker. With reference to FIG. 5, an exhaust release 635 rotatably attaches to the smoker 500 at a point 640. The exhaust release 635 includes apertures 645a-645d arrange to align to apertures (not shown) of the smoker 500. A lever 650 attaches to the exhaust release 635 such that a user may rotate the exhaust release about the point 640. A user may rotate the exhaust release 635 to align, or partially align, the apertures 645a-645d to the apertures of the smoker 500. The user may adjust the temperature within the chamber of the smoker 500 via the exhaust release 635.

In some embodiments, the smoker 500 may include exhaust releases 605, 635 throughout the frame of the smoker 500. A user may adjust the temperature within the chamber of the smoker 500 in accordance with a predetermined cooking temperature based on a function of thickness and cooking time (e.g., the graph 400).

Although various embodiments have been described with reference to the Figures, other embodiments are possible. For example, the marinade including ½ teaspoon of garlic sauce, ½ teaspoon of ground peppercorn and 1 ounce of soy sauce per pound of raw meat strips may be adjusted to accommodate different weights of raw meat strips. For example, two pounds of raw meat strips may dictate that each marinating ingredient be doubled while a fraction of pound may dictate that only a proportional fraction of the marinating ingredients be used.

In some embodiments, other ingredients may be used to make the marinating mix. For example, minced garlic may replace the garlic sauce. Teriyaki sauce may replace the soy sauce. In an illustrative example, Kikkoman® Soy Sauce, commercially available from Kikkoman Sales USA, Inc. of California, may be used to make the marinade. Ingredients may be added to the marinade mix to adjust the flavor. Such ingredients may include honey, chopped garlic, sugar, crushed red pepper or Worcestershire sauce, for example. Any cooking ingredient may be used to make the marinade.

A dehydrator may be used instead of a smoker, for example. A user may adjust the predetermined cooking time, for example, to incorporate the cooking qualities of the dehydrator. In various embodiments, the liquid used with a smoker may be flavored. A user may use a smoker which burns wood, for example, to create the smoke.

A user may aerate the meat strips to accelerate cooking time, for example. The aerated meat strips may reduce the marinating time. The user may aerate the meat strips to achieve a specific texture of the cooked meat strips.

A saturation detection module may be used while marinating the meat strips to ensure proper saturation before cooking. The meat strips may also, for example, be pre-heated before marinating to accelerate the period of time necessary (e.g., first predetermined period of time 155) for marinating the meat strips.

Some aspects of embodiments may be implemented as a computer system. For example, various implementations may include digital and/or analog circuitry, computer hardware, firmware, software, or combinations thereof. Apparatus elements can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Some embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example and not limitation, both general and special purpose microprocessors, which may include a single processor or one of multiple processors of any kind of computer. Generally, a processor will receive instructions and data from a read-only memory or a random access memory or both. The essential elements of a computer are a processor for executing instructions and one or more memories for storing instructions and data. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and, CD-ROM and DVD-ROM disks. The processor and the memory can be supplemented by, or incorporated in, ASICs (application-specific integrated circuits). In some embodiments, the processor and the member can be supplemented by, or incorporated in hardware programmable devices, such as FPGAs, for example.

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. An exemplary embodiment may be implemented in a computer system that includes a graphical user interface and/or an Internet browser. To provide for interaction with a user, some implementations may be implemented on a computer having a display device, such as an LCD (liquid crystal display) monitor for displaying information to the user, a keyboard, and a pointing device, such as a mouse or a trackball by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the first receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, and the computers and networks forming the Internet. Other implementations may transport messages by broadcasting to all or substantially all devices that are coupled together by a communication network, for example, by using Omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Fire wire, ATA/IDE, RS-232, RS-422, RS-485, 802.11 a/b/g, Wi-Fi, WiFi-Direct, Li-Fi, BlueTooth, Ethernet, IrDA, FDDI (fiber distributed data interface), token-ring networks, or multiplexing techniques based on frequency, time, or code division. Some implementations may optionally incorporate features such as error checking and correction (ECC) for data integrity, or security measures, such as encryption (e.g., WEP) and password protection.

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are contemplated.

What is claimed is:

1. A method for manufacturing jerky having a substantially tender texture, the method comprising:
(a) providing at least one slice of a predetermined cut of beef having a thickness in its minor dimension of between about 1/7-inch and about 1/9-inch;
(b) marinating the provided slice in a marinade comprising:
soy sauce, ground peppercorn spice, and edible garlic salt for a predetermined marinate time;
(c) removing the slice from the marinade;
(d) providing a cooking chamber with a cooking rack;
(e) placing the marinated slice onto the cooking rack within the cooking chamber;
(f) cooking the marinated slice by heating the cooking chamber to a temperature of about 350-degree Fahrenheit for a predetermined cooking time;
(g) removing the cooked slice from the cooking chamber; and,
(h) packaging the cooked slice,
wherein the steps (b) through (g) are completed in less than 1 hour.

2. The method of claim 1, wherein the marinade comprises about ½ teaspoon ground garlic salt, about ¾ teaspoon ground peppercorn, and about 1¾ ounce of soy sauce per 1 pound of sliced beef.

3. The method of claim 1, wherein packaging materials for the cooked meat slice includes a desiccant.

4. The method of claim 1, wherein packaging materials for the one or more meat strips includes a sorbent.

5. The method of claim 1, wherein step (b) further comprising an automated dipping station along the path of a conveyor.

6. The method of claim 5, wherein step (e) further comprises transporting the marinated slice into the cooking chamber on the conveyor.

7. The method of claim 1, wherein the cooking chamber maintains a humidity level at a predetermined threshold.

8. The method of claim 1, wherein the predetermined marinate time comprises less than 10 minutes.

9. The method of claim 1, wherein the predetermined cooking time comprises less than 35 minutes.

10. The method of claim 1, wherein the predetermined marinate time comprises less than 5 minutes.

11. A method for manufacturing jerky having a substantially tender texture, the method comprising:
(a) providing at least one slice of a predetermined cut of beef having a thickness in its minor dimension of between about 1/7-inch and about 1/9-inch;
(b) marinating the provided slice in a marinade comprising:
soy sauce, ground peppercorn spice, and edible garlic salt for a predetermined marinate time;
(c) removing the slice from the marinade;
(d) providing a cooking chamber with a cooking rack;
(e) placing the marinated slice onto the cooking rack within the cooking chamber;
(f) cooking the marinated slice by heating the cooking chamber to a temperature of about 350-degree Fahrenheit for a predetermined cooking time;
(g) removing the cooked slice from the cooking chamber; and,
wherein the steps (b) through (g) are completed in less than 1 hour.

12. The method of claim 11, wherein the marinade comprises about ½ teaspoon ground garlic salt, about ¾ teaspoon ground peppercorn, and about 1¾ ounce of soy sauce per 1 pound of sliced meat.

13. The method of claim 11, wherein packaging materials for the cooked meat slice includes a desiccant.

14. The method of claim 11, wherein packaging materials for the one or more meat strips includes a sorbent.

15. The method of claim 11, wherein step (b) further comprising an automated dipping station along the path of a conveyor.

16. The method of claim 1, wherein the predetermined marinate time comprises less than 8 minutes.

17. The method of claim 1, wherein the predetermined cooking time comprises less than 32 minutes.

18. A method for manufacturing jerky having a substantially tender texture, the method comprising:
(a) providing at least one slice of a predetermined cut of beef having a thickness in its minor dimension of about ⅛-inch;
(b) marinating the provided slice in a marinade comprising:
about ½ teaspoon ground garlic salt, about ¾ teaspoon ground peppercorn, and about 1¾ ounce of soy sauce per 1 pound of sliced meat;
(c) removing the slice from the marinade;
(d) providing a cooking chamber with a cooking rack;
(e) placing the marinated slice onto the cooking rack within the cooking chamber;
(f) cooking the marinated slice by heating the cooking chamber to a temperature of about 350-degree Fahrenheit for about 30 minutes;
(g) removing the cooked slice from the cooking chamber; and,
wherein the steps (b) through (g) are completed in less than 1 hour.

19. The method of claim 18, wherein the cooking chamber comprises a gas-powered smoker.

20. The method of claim 18, wherein the predetermined cut of beef comprises flank steak.
